(19) United States
(12) Patent Application Publication
(10) Pub. No.: US 2007/0118832 A1
(43) Pub. Date: May 24, 2007

(54) Method and apparatus for evolution of custom machine representations

(76) Inventor: Lorenz Francis Huelsbergen, Lebano, NJ (US)

Correspondence Address: Ryan, Mason & Lewis, LLP, Suite 205, 1300 Post Road, Fairfield, CT, 06824, US

(21) Appl. No.: 11/282,503

(22) Filed: Nov. 18, 2005

(51) Int. Cl. G06F 9/45

(52) U.S. Cl. 717/151

(57) ABSTRACT

Methods and apparatus are provided for evaluating one or more evolutionary programs or other executable representations, such as circuits. A just-in-time optimization process evaluates an executable representation of an object. Elements of the executable representation of an object are converted to an optimized element set using just-in-time optimization. A distance between a result of the optimized element set and a desired output is evaluated. The optimized element set may optionally be modified based on the results of the evaluation. A specialized interpreter generation process is also disclosed to evaluate a program. The specialized interpreter identifies one or more actions to be performed for each supported instruction. The identified actions are implemented for each instruction in the program to obtain a result. A distance between the result and a desired output is evaluated. The program may optionally be modified based on the results of the evaluation.

### FIELD OF THE INVENTION

This invention relates generally to techniques for evaluating programs and other executable objects and, more particularly, to methods and apparatus for evaluating one or more evolutionary programs or other executable representations.

### BACKGROUND OF THE INVENTION

Computing devices are increasingly searching for other computer programs. The automatic search for interesting programs requires the repeated evaluation of candidate programs to ascertain their fitness for a particular application. Often, this evaluation is performed by a computer program simulating the environment of the target device. Computer simulation of the environment, however, is a tradeoff. While computer simulation allows modeling of environments that are expensive to build or difficult to control in real time, such computer simulation typically incurs very large temporal simulation overheads. Since fitness evaluation is central to evolutionary search and other search methodologies, it is advantageous to remove as much of overhead as possible, while preserving most of the advantages of simulation.

Specifically, if computer programs are being evolved, then a computer may be used directly for evaluating solutions. Alternatively, a computer may be used indirectly to simulate another computer, perhaps through multiple levels of intermediate interpretation. When a search is used to find computer programs, as in the evolutionary computation areas of genetic programming and machine-language induction, both ends of this simulation spectrum have been used by its practitioners. The direct evaluation of bits specifying the program directly on a hardware processor is on one end of this spectrum. The primary advantage of such direct evaluation techniques is its extremely fast execution speed. On the other end of this spectrum is the pure interpretation of the bit string as instructions by a software interpreter. Interpretation gives great flexibility to the design of a custom instruction set architecture (ISA) and to the subsequent evaluation of programs written in it. For example, restricting evaluation to a maximum fixed number of instructions, a central issue in the presence of loops, is easy with an interpreter but tricky when raw bits are run natively on a general purpose machine.

Speed, flexibility, and control are all desirable in the evaluation of a program representation since they contribute to the overall efficacy of the evolutionary paradigm. Fast evolution of bits on a microprocessor helps find solutions quickly. Custom ISAs allow targeting of a particular region (and often a smaller region) of the solution space. Custom instruction sets can avoid finding programs that might disrupt the search environment, such as those that might reset the machine.

The programming language and compiler communities have employed “just-in-time” compilation and interpreter specialization techniques to evolve programs. P. Nordin, “A Compiling Genetic Programming System that Directly Manipulates the Machine-Code,” Advances in Genetic Programming, Ch. 14, 311-31 (MIT Press, 1994), describes a technique that attempted to evolve programs directly on microprocessor instruction sets. The “brittleness” of such representations (i.e., changing a single bit can create a program that crashes the machine) led others to design methods for containing the evolution of machine code by essentially using the operating system to trap exceptions (such as invalid memory addresses). See, e.g., F. Kuhling et al., “Brute-Force Approach to Automatic Induction of Machine Code on CISC Architectures,” Genetic Programming, Proc. of the 5^{th} European Conf., EuroGP 2002, vol. 2278 of LNCS, 288-97 (April, 2002). The substantial required operating system support curtails portability across systems and operating systems, making its implementation inaccessible to most practitioners.

It has been observed that the search space of such representations is quite large since it encompasses the ISA of the underlying native machine. This makes solutions difficult since the search space is; “polluted” by instructions that cannot contribute to the desired solution. Furthermore, many instruction codings may now result in an operating system trap, which can increase the cost of executing such an instruction.

A need therefore exists for improved methods and apparatus for evaluating one or more evolutionary programs or other executable representations. A further need exists for methods and apparatus for evaluating one or more evolutionary programs or other executable representations that safely allow the program or other executable representation to be evaluated.

### SUMMARY OF THE INVENTION

Generally, methods and apparatus are provided for evaluating one or more evolutionary programs or other executable representations, such as circuits. According to one aspect of the invention, a just-in-time optimization process evaluates an executable representation of an object, such as a program or a circuit. The exemplary just-in-time optimization process initially converts elements of the executable representation of an object to an optimized element set using just-in-time optimization. Thereafter, the just-in-time optimization process evaluates a distance between a result of the optimized element set and a desired output. The optimized element set may optionally be modified based on the results of the evaluation.

According to another aspect of the invention, a specialized interpreter generation process evaluates a program. The specialized interpreter generation process obtains a specialized interpreter generated by compiling an instruction set specification for a plurality of supported instructions. The specialized interpreter identifies one or more actions to be performed for each supported instruction. The specialized interpreter can be, for example, a table having an entry for each instruction and operand pair. Each entry in the specialized interpreter optionally indicates a precomputed state to move to following execution of the corresponding instruction. The specialized interpreter generation process implements the one or more identified actions for each instruction in the program to obtain a result. A distance between the result and a desired output is evaluated. The program may optionally be modified based on the results of the evaluation.

A more complete understanding of the present invention, as well as further features and advantages of the present invention, will be obtained by reference to the following detailed description and drawings.

### BRIEF DESCRIPTION OF THE DRAWINGS

FIG. 1 illustrates a portion of a register-machine interpreter written in C that is used for fully interpreted machine-language induction experiments;

FIG. 2 illustrates the operational semantics of an exemplary Virtual Register-Machine; FIG. 3 illustrates the translation of the VRM of FIG. 2;

FIG. 4 is a flow chart describing an exemplary implementation of a just-in-time optimization process incorporating features of the present invention;

FIG. 5 illustrates a small portion of a specialized interpreter corresponding to the interpreter fragment of FIG. 1;

FIG. 6 is a flow chart describing an exemplary implementation of a specialized interpreter generation process incorporating features of the present invention; and

FIG. 7 is a block diagram of a evolutionary program evaluation system that can implement the processes of the present invention.

### DETAILED DESCRIPTION

The present invention provides methods and apparatus for evaluating one or more evolutionary programs or other executable representations. While the present invention is illustrated herein in the context of an exemplary just-in-time compilation of programs, the present invention can be applied to more general optimizations of programs, as well as to optimizations of circuits and other executable representations, as would be apparent to a person of ordinary skill in the art. For a detailed discussion of a number of well known optimizations, see, for example, A.V. Aho et al., Compilers, Principles, Techniques and Tools (1986), incorporated by reference herein. For example, the present invention can also be implemented using “Peep Hole” optimizations, where a window of program instructions are evaluated to remove redundant instructions or to otherwise reduce the number of instructions to be executed, or other exemplary optimizations to remove “dead code” that is not reachable or executed.

The present invention provides two exemplary techniques, referred to herein as just-in-time compilation (JITC) and specialized interpreter generation (SIG), for efficient evaluation of custom machine-language ISAs. While the present invention is illustrated in the context of machine-language induction, the disclosed techniques can be applied to other domains, as would be apparent to a person of ordinary skill in the art. For example, the disclosed JITC or SIG techniques can be applied to speed evaluation of executable representations, including circuits and Lisp expressions typically used in Koza-style genetic programming, as well as other types of executable representations. It is noted, however, that JITC in particular is most useful for evolvable representations that contain loop constructs since some run-time cost is incurred when new individuals are created.

According to one aspect of the invention, JITC does an on-the-fly translation of custom instructions of a program to the underlying machine language of the hardware. JITC can be fast; only a single translation pass over the program is required. Typically, a custom instruction will translate into a small number (such as 3-5) of machine instructions, which is much less than the number of machine instructions required for its interpretation. Bookkeeping code for terminating execution in the presence of long or infinite loops, for example, adds significantly to the complexities of interpretation. JIT compilation produces machine code to perform these tasks quickly as well.

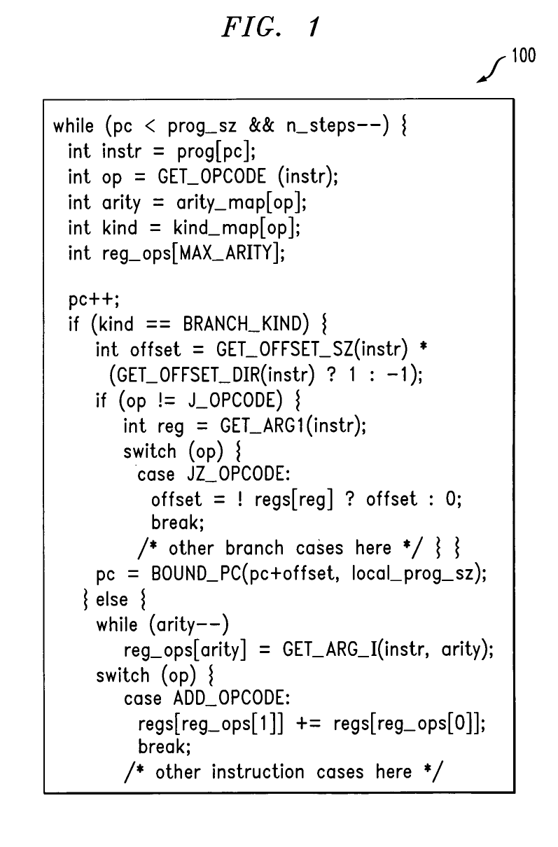

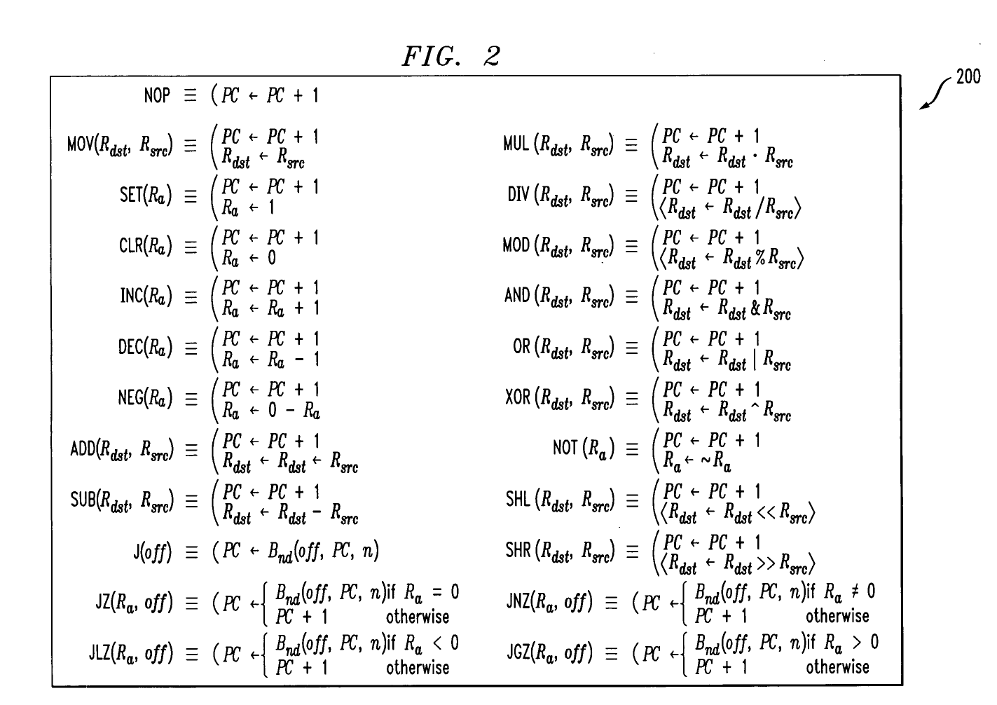

FIG. 1 illustrates a portion of a register-machine interpreter written in C used for fully interpreted machine-language induction experiments. Only the code for a couple of instructions is shown: a branch (JZ_OPCODE) and addition (ADD_OPCODE). The full interpreter is much larger, on the order of a few hundred lines of C code. The operational semantics of the full interpreter are discussed below in conjunction with FIG. 2. There are significant overheads to interpretation due to the task of instruction decoding. In the interpreter code, one can see that the instruction kind must be determined as well as the arguments to the instruction (reg_ops). Furthermore, the program counter (pc) must be maintained. A good C compiler can eliminate blatant overheads in this code, but the essential task of decoding custom instruction remains, as well as the control of the interpretation.

According to another aspect of the invention, specialized interpreter generation (SIG) improves the speed of machine representations. It is well known in the programming language and compiler communities that for small instruction sets, such as for instructions where opcodes and operands are contained in 16 bits, one can trade space for time and generate a (potentially large) custom interpreter that essentially makes every possible instruction and operand combination a special case. The SIG approach is simpler than a JIT compilation system and is also largely machine and OS independent, but does still incur runtime overhead due to its instruction dispatch loop; whereas JITC creates a true program that does not require interpretation. SIG can be substantially faster than pure interpretation since all instruction decoding operations are removed. As shown in FIG. 1, SIG removes, for example, the tests for determining the kind of instruction being decoded and for parsing its register operands.

### Virtual Register-Machine Interpreter

This section provides a sample custom ISA that has been used for evolving machine language programs requiring evolution of loop structures. It is noted that the Virtual Register-Machine (VRM) consists of an external state in the form of a set of virtual registers, an internal state in the form of a program counter, and instructions.

FIG. 2 illustrates the operational semantics of an exemplary Virtual Register-Machine. In the notation of FIG. 2, an arithmetic or logical operator on the right-hand side generally inherits the C language's semantics of that operator. Expressions enclosed in <brackets> yield zero on exceptional cases (e.g., divide-by-zero or invalid shift amounts). The Virtual Register-Machine of FIG. 2 includes instructions similar to those of contemporary processors that perform arithmetic, move data, and set and/or clear bits. Branch instructions allow synthesis of arbitrary control flow. This unrestricted control flow is important because it enables solution of non-trivial problems by synthesizing complex control structures such as loops and recursion.

External State: Registers

The register state is defined as a vector:
\vec{R}≡<R₀, . . . Rₘ₋₁>
of m signed integers. The register state constitutes the machine's mutable memory. The precision of a register is inherited from the underlying implementation. Many program instructions (e.g., ADD) modify registers directly.

Internal State: PC

In addition to the external register state, the VRM maintains a piece of internal state: a program counter (PC). The PC is an integer, 0≦PC<n, that selects which instruction to fetch and execute. Branch instructions modify the PC by adding a signed offset to it; all other instructions always increment the PC by one. The PC is initially zero.

Instruction Set

A program is a vector of n instructions:
\vec{I}≡<I₀, . . . , Iₙ₋₁>.
The program counter corresponds to an index of \vec{I}. A program terminates when PC=n, that is, when evaluation steps past the end of the program. Note that an interpreter must explicitly maintain the PC. One advantage of this is that it is easy to limit the maximum number of instruction evaluated; the disadvantage is that it must expend many cycles for its maintenance.

As shown in FIG. 2, the VRM's ISA consists of a register move instruction, MOV, an unconditional branch, J, branches conditional on a register's value relative to the zero value (JZ, JNZ JLZ, JGZ), instructions that initialize registers (SET and CLR), instructions to increment (INC) and decrement (DEC) a given register, and a nullary instruction NOP that does nothing. The arithmetic instructions (ADD, SUB, MUL, DIV, MOD) perform the respective two's complement operation on source and destination, leaving the result in the destination register. The arithmetic NEG instruction negates the value in its argument register. The arithmetic instructions mimic C's behavior and “wrap around” on the exceptional conditions of integer overflow (or underflow) instead of trapping. Arithmetic operations that can generate traps in C are DIV and MOD that are susceptible to divide-by-zero. The disclosed VRM evaluator checks for zero divisors, a condition that is (arbitrarily) defined to place zero in the destination register. Note JITC and SIG must handle such exceptions.

Branches (J, JZ, JNZ, JLZ, JGZ) are always relative to the program counter. Negative offsets describe a backward branch. Note that the operational semantics rewrite a branch to an address<0 as a branch to I₀ (i.e., PC←0) and a branch past the end of the program (n−1) as termination (i.e., PC←n). A jump instruction Iⱼ, can therefore branch to any one of n+1 distinct addresses. The conditional branches are parameterized by a register and the jump displacement. JZ branches if the register is zero. JNZ branches on any value but zero. JLZ branches on a negative, and JGZ on a positive, register value.

The six bit-wise logical instructions found in the right hand column of FIG. 2 perform their namesake's operation and are defined in terms of the respective C operators. A departure from this semantics is the interpretation of the shift operators as NOPs if the shift amount is either negative or exceeds the number of bits comprising an implementation register. Since VRM registers are signed, a right shirt (SHR) of a negative quantity will effectively “reset” the sign bit.

### Just-in-Time (JIT) Compilation

This section shows how a simple, but fairly complete VRM can be translated by JIT compilation to native machine instructions. Auxiliary machinery necessary to evaluate the translated program is then described. Two extensions to the translation for custom representations are also provided that:
1. require more registers than available on the native machine (as may well be the case for Intel x86 architectures), and
2. access non-register memory with load/store instructions.

The translation assumes without loss of generality that the underlying machine is a reduced instruction set processor (RISC) and uses in particular the MIPS instruction set architecture as the target native machine. This choice of the MIPS as the ISA is somewhat arbitrary; however, the MIPS ISA is simple enough that, with the explanation in this text, its semantics should be clear and substitution of other common ISAs is straightforward.

Translation

FIG. 3 illustrates the translation of the VRM of FIG. 2. After describing the strategy for maintaining internal VRM state, the translation itself is described for a representative sample of instructions.

The result of JIT translation of a VRM program P is a linear sequence of native machine instructions comprising a native machine program P′. Since P′ is no longer governed by an interpreter loop, it must manage its own state, both (program counter) and external (registers). This is accomplished by mapping this state to the hardware's register set.

The function of the VRM program counter is subsumed by the PC of the native machine. However, the flexibility of the interpreted VRM must be retained in that it should be possible to select the exact number of translated VRM instructions to be executed. This can be accomplished by dedicating a machine register, denoted rₜ, to holding the number of VRM instructions remaining to be evaluated. To terminate the program after N VRM instructions, rₜ is loaded with N at the start of execution of P′. JITC inserts, before the translation of every VRM instruction, a check to see if rₜ has reached zero and, if so, to terminate the program by branching to an absolute label. This label, denoted l_term in FIG. 3, is where control should flow after the program terminates. A logical point is at the end of P′ since “falling off the end” of P′ signifies termination as well. It may, however, be placed anywhere convenient; if it is not placed at the end of P′, an unconditional branch instruction to l_term must be placed after the last translated instruction in P′.

The two-instruction macro, termchk_macro, defined and used in FIG. 3, performs the task of decrementing the termination register and checking whether it has reached zero. Note that the VRM's NOP instruction translates into this macro. Also note that all VRM instruction translations begin with termchk_macro.

The VRN's external state of registers is mapped into the native hardware's general purpose register (GPR) set. To allow this, it is necessary to save all GPR's to spill memory before executing P′ and to restore these registers after l_term is reached. Here, it is assumed that the number of VRM registers is less than the number of free GPR's; below, a description is provided of how additional registers may be virtualized using some additional memory.

Note that in the MIPS architecture register r₀ is tied to zero. Therefore, the mapping of VRM registers to native GPR's starts with register r₁. In addition to rₜ, another GPR, denoted rₜₘₚ, is reserved for use as temporary storage. Depending on the representation being translated, more (or perhaps fewer) dedicated registers may be required.

The actual translation of VRM instructions is straightforward. This is due to the VRM being very close to contemporary machine languages. Note, however, that the MIPs instruction set uses the arithmetic instruction for addition add for many purposes, including register-to-register transfer. The MOV instruction, for example, becomes an addition of the source register to the zero register with the result placed in the destination register. Other instructions such as SET, CLR, INC, DEC, and ADD, can be defined in terms of MIPS′ add or addi instructions. The MIPS sub instruction is used similarly for NEG and SUB.

Note the arithmetic functions of multiplication and division translate to multiple MIPS instructions. Also, MIPS does not define an exception condition for division by zero or arithmetic overflow. (In the case of divide-by-zero the result is undefined.) If it is necessary for the VRM to identify such conditions, additional instructions must be inserted by the translation to, for example, check if the r_{src} register is zero. If so, a conditional branch instruction can transfer control to l_term or elsewhere.

The translation of VRM's branch instructions is also quite direct. Most instructions have a direct MIPS analog, but special treatment is required for the relative branch off-set. The correct offset is computed by JITC as it processes a branch instruction by the fix_offset function, which takes the VRM offset and the instruction number in the program and computes the target instruction in the resulting translation. Such translation is necessary since in the VRM it was possible to branch past both the start and beginning instruction of the VRM program. Also, since VRM instructions now translate into multiple native (MIPS) instructions and this number is variable from instruction to instruction, fix_offset must compute the appropriate native relative offset. Because the address of forward VRM branch instructions are not known during the translation pass, the location of the incomplete native branch offset must be retained and resolved once all VRM instructions have been processed. Auxiliary data structures are necessary for the JIT compiler to resolve such issues.

Auxiliary Data Structures

The following data structures support JIT translation. First, a block of executable memory B large enough to hold the translated program P′ is needed. As indicated above, this block may require prologue code to spill registers that are in use and epilogue code to restore them. Prologue code can be used to initialize registers and epilogue code can return the program's output from registers.

Second, a vector V of native start addresses for VRM instructions is used in resolving branches (both forward and backward). The manner in which V aids in implementing operators like crossover is discussed below. Note that one can dispense with maintaining V entirely by making all VRM instructions translate into the same number of native instructions; one can pad translations shorter than the longest instruction with MIPS nop's. If this is done; the instruction number suffices to determine the start of the instruction in B. This simplifies JIT compilation and evolutionary operator implementation, but significantly slows the evaluation.

Another data structure useful for implementing the evolutionary operators is a type vector J. This vector denotes whether an instruction is a branch or not, and if so, what its offset is in the corresponding VRM program. This information is necessary to process branch instructions after relocation by an evolutionary operator (see below) since the compiled offsets computed by fix_offset may need to be recomputed when an evolutionary operator moves an instruction, for example.

Evolutionary Operators

When applied to a program representation, evolutionary operators—such as crossover, point-wise mutation, or macro-mutation, shuffle program instructions or replace existing instructions with new ones.

To implement crossover between two parents X and Y to produce offspring Z, for instance, the system allocates a new executable memory block B_{Z} and copies the desired translated instructions from the parent blocks B_{X} and B_{Y} successively into B_{Z}. The instruction-address vectors V_{X} and V_{Y} defined above aid this copying. As defined in FIG. 3, all instructions except for the branch instructions are relocatable; that is, they may be moved to a new address without change. Branch instructions, however, may need to have their offsets recomputed by fix_offset since their location within the program may have changed. For example, an instruction i that in the VRM program branched past the end of the program may no longer do so after a crossover operation since i may have been moved to the beginning of the resulting offspring. The type vectors J_{X} and J_{Y} are used to find the branch instructions in Z inherited from X and Y and the address vectors V_{X} and V_{Y} are used in reapplying fix_offset. Note that new address and type vectors V_{Z} and J_{Z} are formed for Z during this process.

Mutations and macro-mutations are implemented similarly through copying in general. Since different VRM instructions can translate into differing numbers of native instructions, full copying may be necessary. However, it may be possible to perform a mutation in place if the number of native instructions comprising the VRM instruction being mutated is larger than the number of native instructions comprising the mutation. Again, the vector V can be use to determine this.

Translating Memory Operands

An important class of instructions absent from the sample VRM (FIG. 2) is memory load/store instructions. In the VRM, all memory is contained in the register state. However, experimenters may wish to evolve programs with instructions that have memory operands.

A simple way to translate memory instructions is as follows. A runtime block of memory M is allocated as “the memory” and initialized by the prologue code if necessary. A VRM instruction that then indexes into this memory, say ADD(r_{dst},M[r_{index}]), would insert native instructions to test if the value of r_{index} is in range; that is, a bounds check, 0≦r_{index}<|M|, would occur to restrict access to memory outside of the allocated block M. Instructions writing to memory would similarly be bounds checked.

Simulating Additional Registers

In the above, it was assumed that the number of register specified by the VRM fits into the registers on the processor of the target machine. For some contemporary processors (e.g., Intel's x86) this may not be the case. Here, the translation of a set of virtual registers that cannot be mapped directly into available machine registers is discussed using standard compiler techniques.

A bank of m registers is allocated as a block of m memory words (where a word can hold a single VRM register typically 32 or 64 bits). Denote this block as vrb. When a VRM register is referenced by a VRM instruction, the translation uses native temporary registers to load the virtual register from its location in vrb. The specified operation is performed on the temporary registers and the result is written back to the appropriate places in the vrb as necessary.

Consider translation of ADD(r₉, r₁₅) as an example:

| | | |
|---|---|---|
| st | spill0, tmpreg0 | #free tmp regs |
| st | spill1, tmpreg1 | |
| ld | tmpreg0, vrb(15] | #get operands |
| ld | tmpreg1, vrb[9] | |
| add | tmpreg0, tmpreg0, tmpreg1 | #do add |
| st | vrb[9], tmpreg0 | #update result reg |
| ld | tmpreg0, spill0 | #restore tmp regs |
| ld | tmpref1, spill1 | |

Here, r₉ and r₅ reside at offsets 9 and 15 of the vrb, respectively. If the temporary native registers are in use (or it is not known if they are), they must be saved in a spill area and restored from this area when the addition operation completes. Also note that the result of the addition (in tmpreg0) is written back to the virtual destination register at vrb[9].

Optimization

The translation described in this section can be further improved by using compiler optimization techniques as cataloged in standard compiler texts, such as A.V. Aho et al., Compilers, Principles, Techniques and Tools (1986). Additional translation effort can be used to do peep hole optimization (PHO) within a small window of generated native instructions. PHO and other more costly optimizations can have a dramatic effect on the runtime of the translated program. However, the cost of the optimization must also be taken into account—one must be sure to recoup the time spent optimizing through time saved evaluating the resulting program.

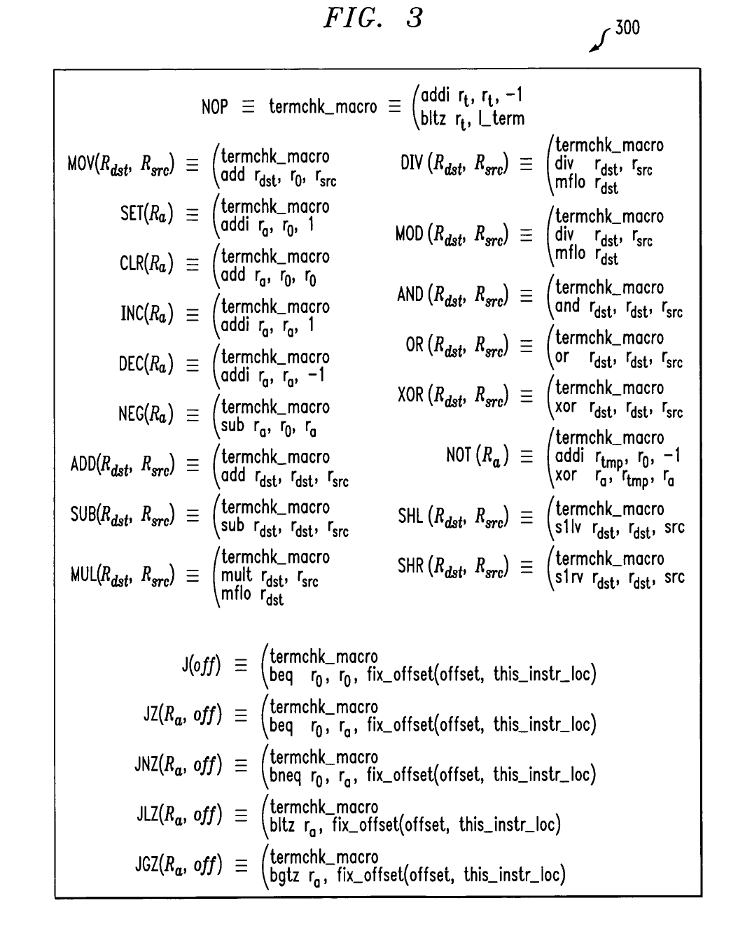

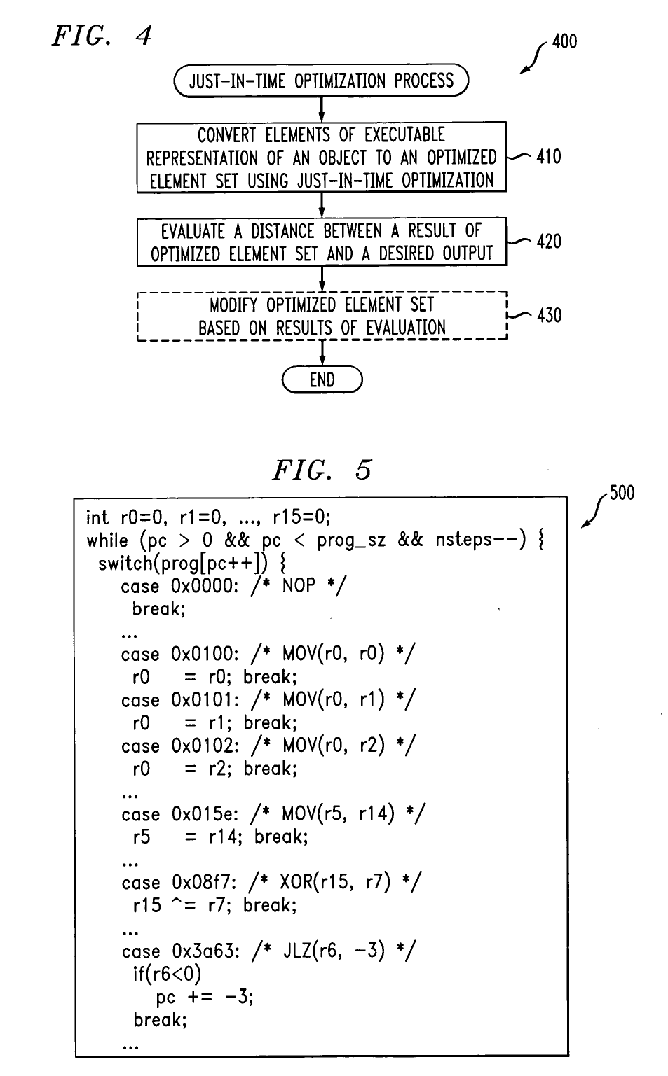

FIG. 4 is a flow chart describing an exemplary implementation of a just-in-time optimization process 400 incorporating features of the present invention. Generally, the just-in-time optimization process 400 evaluates an executable representation of an object, such as a program or a circuit. As shown in FIG. 4, the just-in-time optimization process 400 initially converts elements of the executable representation of an object to an optimized element set using just-in-time optimization during step 410. Thereafter, the just-in-time optimization process 400 evaluates a distance between a result of the optimized element set and a desired output during step 420. The optimized element set may optionally be modified during step 430 based on the results of the evaluation.

When the executable representation is a circuit, for example, the just-in-time optimization performed during step 410 adds, removes or modifies one or more circuit elements associated with the circuit.

When the executable representation is a program, the just-in-time optimization performed during step 410 is a just-in-time compilation or another optimization. A just-in-time compilation converts instructions of the program to an optimized instruction set, such as machine code.

### Specialized Interpreter Generation (SIG)

Another technique to speed interpreter evaluation is by specializing the interpreter for all possible instruction/operand combinations that may occur. Though not as speedy as programs produced by JIT compilation, SIG can remove the instruction decoding overheads from the loop of the interpreter. A primary advantage of SIG is that it is very simple to implement and that it is portable across compilers and operating systems.

A prerequisite for using SIG is that the total number of opcode/operand combinations be manageable (i.e., this number be small enough that a jump table constructed in memory for dispatching every such combination. For counting the number of such combinations in a VRM see, for example, L. Huelsbergen, “Finding General Solutions to the Parity Problem by Evolving Machine-Language Representations, Proc. of the 3d Conf. on Genetic Programming, 158-66 (July, 1998). More precisely, for a given VRM, SIG will produce a multi-way “switch” statement where every “case” (or “label”) is one of the possible combinations. This table must be small enough to fit in memory and it should furthermore be possible to compile the resulting switch statement with a C or Java compiler. Opcodes/operands encoded in 16 bits and hence resulting in 2¹⁶ cases are readily compiled by conventional C compilers. In practice, 20 or 24 bit opcodes should be possible, but many interesting VRMs can already be defined with 16 bits.

FIG. 5 gives a small portion of a specialized interpreter corresponding to the interpreter fragment of FIG. 1. The VRM of FIG. 5 is again the VRM of FIG. 2 and it is instantiated to 16 registers. The encoding is into 14 bits as follows. For single register opcodes, the top bits 8-13 are zero, the opcode is encoded in bits 4-7, and bits 0-3 contain the register. For branch instructions, the top bit (bit 13) is one and bits 8-11 encode the branch opcode; bits 4-7 contain the register (for a conditional branch) and bits 0-3 contain the offset with the offset's sign encoded in bit 12. The remaining two register operand instructions are encoded with bits 12-13 zero, the opcode in bits 8-11, and the register pair in the lower byte.

It is important to note that a good compiler will produce code for the cases very similar to that of the JITC approach due to the fact that VRM registers have been mapped directly to variables and not to arrays as in the slow interpreter of FIG. 1. This removes many memory references since indirection through an array address is no longer necessary to fetch/store VRM registers.

Since the encoding of the VRM can be made identical for standard interpretation (FIG. 1) and for SIG, branch instructions that required special treatment for JITC can be processed as before. SIG retains the interpreter loop and can easily detect program counters that fall outside the program proper. Relatedly, implementation of the evolutionary operators for SIG is also simple. Evolutionary operators can shuffle and modify the program array in an unrestricted manner since the interpreter loop again checks for valid program counter conditions. As with the raw execution of bits on native hardware and unlike JIT compilation, SIG can admit crossover (and other evolutionary operators) at bit boundaries if all possible opcode values are defined.

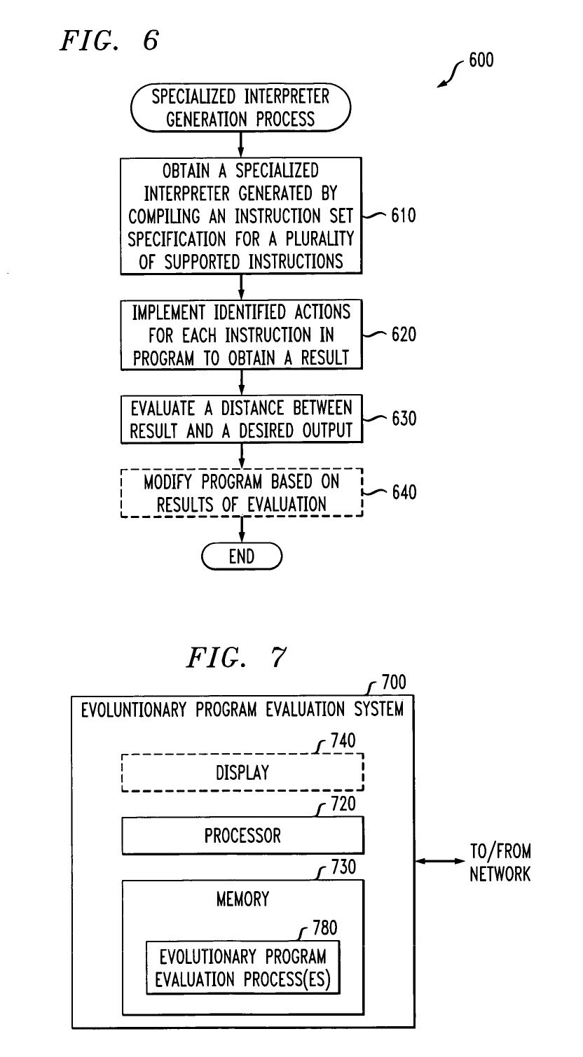

FIG. 6 is a flow chart describing an exemplary implementation of a specialized interpreter generation process 600 incorporating features of the present invention. Generally, the specialized interpreter generation process 600 evaluates a program. Initially, the specialized interpreter generation process 600 obtains a specialized interpreter during step 610 that was generated by compiling an instruction set specification for a plurality of supported instructions. The specialized interpreter identifies one or more actions to be performed for each supported instruction. The specialized interpreter can be, for example, a table having an entry for each instruction and operand pair. Each entry in the specialized interpreter optionally indicates a precomputed state to move to following execution of the corresponding instruction.

Thereafter, during step 620, the specialized interpreter generation process 600 implements the one or more identified actions for each instruction in the program to obtain a result. A distance between the result and a desired output is evaluated during step 630. The program may optionally be modified during step 640 based on the results of the evaluation.

While FIGS. 1 through 6 show an example of a sequence of steps, it is also an embodiment of the present invention that the sequence may be varied. Various permutations of the algorithm are contemplated as alternate embodiments of the invention.

FIG. 7 is a block diagram of a evolutionary program evaluation system 700 that can implement the processes of the present invention. As shown in FIG. 7, memory 730 configures the processor 720 to implement the methods, steps, and functions disclosed herein (collectively, shown as 780 in FIG. 7). The memory 730 could be distributed or local and the processor 720 could be distributed or singular. The memory 730 could be implemented as an electrical, magnetic or optical memory, or any combination of these or other types of storage devices. It should be noted that each distributed processor that makes up processor 720 generally contains its own addressable memory space. It should also be noted that some or all of computer system 700 can be incorporated into an application-specific or general-use integrated circuit.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

I claim:

1. A method for evaluating an executable representation of an object, said method comprising:
converting elements of said executable representation of said object to an optimized element set using just-in-time optimization; and
evaluating a distance between a result of said optimized element set and a desired output.

2. The method of claim 1, further comprising the step of modifying said optimized element set based on said evaluating step.

3. The method of claim 1, wherein said executable representation of an object is a circuit.

4. The method of claim 3, wherein said just-in-time optimization comprises one or more of adding, removing or modifying one or more circuit elements associated with said circuit.

5. The method of claim 1, wherein said executable representation of an object is a program.

6. The method of claim 5, wherein said just-in-time optimization comprises ajust-in-time compilation.

7. The method of claim 6, wherein said just-in-time compilation converts instructions of said program to an optimized instruction set.

8. The method of claim 7, wherein said optimized instruction set comprises machine code.

9. The method of claim 5, wherein said converting step further comprises the steps of identifying one or more jump instructions in said program; and identifying target addresses of said identified jump instructions to account for an offset in corresponding machine code.

10. The method of claim 5, wherein said converting step further comprises the step of translating each instruction in said program into zero or more native machine instructions that simulate intended semantics of a corresponding instruction.

11. The method of claim 10, wherein said translating step further comprises the step of inserting one or more instructions to account for exceptional cases.

12. The method of claim 11, wherein said exceptional cases include one or more of an endless loop, division-by-zero, invalid shift amounts, and arithmetic overflow

13. The method of claim 5, wherein said converting step further comprises the step of mapping from virtual registers to hardware registers or memory locations.

14. The method of claim 6, wherein said just-in-time compilation makes an evaluation of said program safe.

15. A method for evaluating a program, said method comprising:
obtaining a specialized interpreter generated by compiling an instruction set specification for a plurality of supported instructions, said specialized interpreter identifying one or more actions to be performed for each of said plurality of supported instructions;
implementing said one or more identified actions for each instruction in said program to obtain a result; and
evaluating a distance between said result and a desired output.

16. The method of claim 15, wherein said specialized interpreter is a table having an entry for each instruction and operand pair

17. The method of claim 16, wherein each entry in said specialized interpreter indicates a precomputed state to move to following execution of said corresponding instruction.

18. The method of claim 17, wherein said precomputed state includes one or more of a modification to one or more registers, a modification to a program counter and a navigation through a state machine.

19. The method of claim 15, further comprising the step of modifying said program based on said evaluating step.

20. An apparatus for evaluating an executable representation of an object, the apparatus comprising:
a memory; and
at least one processor, coupled to the memory, operative to:
convert elements of said executable representation of said object to an optimized element set using just-in-time optimization; and
evaluate a distance between a result of said optimized element set and a desired output.

21. An apparatus for evaluating a program, the apparatus comprising:
a memory; and
at least one processor, coupled to the memory, operative to:
obtain a specialized interpreter generated by compiling an instruction set specification for a plurality of supported instructions, said specialized interpreter identifying one or more actions to be performed for each of said plurality of supported instructions;
implement said one or more identified actions for each instruction in said program to obtain a result; and
evaluate a distance between said result and a desired output.
